(19) United States
(12) Patent Application Publication
(10) Pub. No.: US 2019/0305720 A1
(43) Pub. Date: Oct. 3, 2019

(54) MOBILE SOLAR DEVICE

(71) Applicant: SOLAR NETWORKS SP. Z.O.O., Leszno (PL)

(72) Inventor: Radoslaw Rogalka, Leszno (PL)

(21) Appl. No.: 16/462,598

(22) PCT Filed: Nov. 22, 2017
(86) PCT No.: PCT/IB2017/057334

§ 371 Date: May 21, 2019

(30) Foreign Application Priority Data
Nov. 23, 2016 (PL) P-419578

(51) Int. Cl. H02S 30/20; H02S 10/40; H02S 30/10; B65D 88/12

(52) U.S. Cl. CPC H02S 30/20; B65D 88/121; H02S 30/10; H02S 10/40

(57) ABSTRACT

A mobile solar device (1) includes a substantially rectangular container (1) that includes two front walls (3), an upper wall (5) and a bottom wall (4) in fixed operative connection. The container includes removable sidewalls (2) that provide rectangular openings (26) to a container interior area (27). A plurality of rectangular frames (8) each have attached thereto a plurality of solar panels (7). Rectangular frames are movable transversely outward from a retracted position in the container interior area in guided relation on transverse guides (10, 11) to extend outward through a container opening. The rectangular frames are then movable along a longitudinal direction away from the container opening in guided relation on longitudinal guides (13, 14) to an extended position. In the extended position the solar panels may be selectively angularly positioned relative to the rectangular frames. The container interior area contains a battery (21) and a control system (20) for storing and delivering electrical power generated by the solar panels.

### TECHNICAL FIELD

An exemplary embodiment is a mobile solar device intended for the acquisition and conversion of electrical energy from solar energy and for storing it. In particular, the exemplary mobile solar device is intended for supplying energy in areas difficult to access or crisis areas.

### BACKGROUND

There are prior solutions for mobile solar devices.

U.S. Pat. No. 7,230,819 B2 which is incorporated herein by reference in its entirety discloses a mobile solar device in which the solar panels are located on the upper wall and at least one side wall of the container. Each solar panel cooperates with an angular control system attached to the corresponding wall on which the panel is located. In operation the solar panels are angularly deflected from the container walls and set towards the sun.

US Patent Publication 2010/0206354 A1A which is incorporated herein by reference in its entirety discloses a mobile power system in which solar panels are located inside the container. During operation solar panels are extended from the front wall of the container and set towards the sun.

European Patent Application EP 2 822 178 A1 which is incorporated herein by reference in its entirety includes solar panels located inside the container as well as on its upper wall and at least one side wall. Additionally, the panels located on the walls of the container are covered from the outside with boards e.g. wooden or cork, which further protect the panels not located inside the container against the influence of unfavourable external factors or transport effects. On the front walls the container is provided with a door through which, during operation, the internal solar panels are pulled out of the container, slid and unfolded outwards angularly towards the sun. The outer panels are angularly deflected and the same as the interior panels set towards the sun.

### SUMMARY

Exemplary embodiments provide an improved container design incorporating a mobile solar device for protecting solar panels against the adverse influence of environmental factors and transport and, at the same time, easier and faster assembly of the finished system for the operating mode.

An exemplary mobile solar device includes substantially flat construction modules with solar panels, which are integrated with the charging control system and an energy battery with a substantially rectangular container comprising two longitudinal side walls, two front walls and a bottom wall and an upper wall. The solar panels are located in frame structures in an extendable manner. The exemplary device has at least one longitudinal side wall of the container with a transverse extension unit, whereon the frame structure with construction modules with the solar panels is suspended in an extendable manner. The construction modules with the solar panels are slidable in a plane perpendicular to the extending direction of the transverse extension unit.

In an exemplary arrangement two longitudinal side walls of the container are provided with respective transverse extension units.

In an exemplary arrangement the transverse extension device comprises bottom transverse guides and upper transverse guides located at the bottom and on the upper wall inside the container, whereby the transverse carriage carries the frame structures.

In an exemplary arrangement the transverse extension unit comprises at least two pairs of bottom transverse guides and upper transverse guides located parallel to each other.

In an exemplary embodiment the frame structure is slidably lowered in a main longitudinal bottom guide, and at the top in a main longitudinal upper guide by means of longitudinal carriages. The longitudinal bottom guide is mounted on the bottom transverse carriages and the main longitudinal upper guide is mounted on the upper transverse carriages.

In an exemplary arrangement the frame structure comprises at least one extendable frame structure provided with a construction module with the solar panels, wherein the extendable frame structure is attached slidably to the frame structure by means of rollers along one of the longer sides of the frame structure and the carriage slidably mounted in a longitudinal frame guide which is attached to the frame structure along the second of its longer sides.

In an exemplary arrangement the frame structure comprises at least two frame structures.

In an exemplary arrangement frame structures are arranged in the container one after the other.

In an exemplary arrangement the frame structure has folding legs at the bottom.

In an exemplary arrangement the solar panels are angularly deflected from the top of the frame structures.

In an exemplary arrangement the charging control system and the energy battery are located inside the container.

### BRIEF DESCRIPTION OF DRAWINGS

The exemplary arrangements are represented in an embodiment shown in the drawings, in which

FIG. 1 shows a perspective view of a mobile solar device according to an exemplary arrangement.

FIG. 2 shows a perspective view of the mobile solar device with an open longitudinal side wall.

FIG. 3 shows a perspective view of a container for the mobile solar device with fragmentary elements of the transverse extension unit.

FIG. 4 shows a perspective view of a transverse bottom guide with a transverse carriage mounted therein.

FIG. 5 shows a perspective view of a container for the mobile solar device with bottom and upper longitudinal guides.

FIG. 6 shows a perspective top view of a mobile solar device with frame structures extended from the container.

FIG. 7 shows a perspective view of the mobile solar device with frame structures extended and unfolded frame structures.

FIG. 8 shows a perspective view of the mobile solar device in operation with solar panels angularly deflected towards the sun and a fragmentary enlarged angular deflection system.

FIG. 9 shows a perspective front view of an unfolded frame structure with an extendable frame structure.

FIG. 10 shows a perspective rear view of an unfolded frame structure with an extendable frame structure.

FIG. 11 A shows the lower attachment of longitudinal carriages to the frame structure.

FIG. 11 B shows the upper attachment of longitudinal carriages to the frame structure.

FIG. 12 shows a longitudinal frame guide together with a carriage attached to the frame structure.

FIG. 13 shows rollers guiding an extendable frame structure along the longitudinal side of the frame structure.

FIG. 14 is a top view of the container.

FIG. 15 shows a section taken along line 15-15 in FIG. 14 through the exemplary container which shows the visible elements of its equipment.

### DETAILED DESCRIPTION

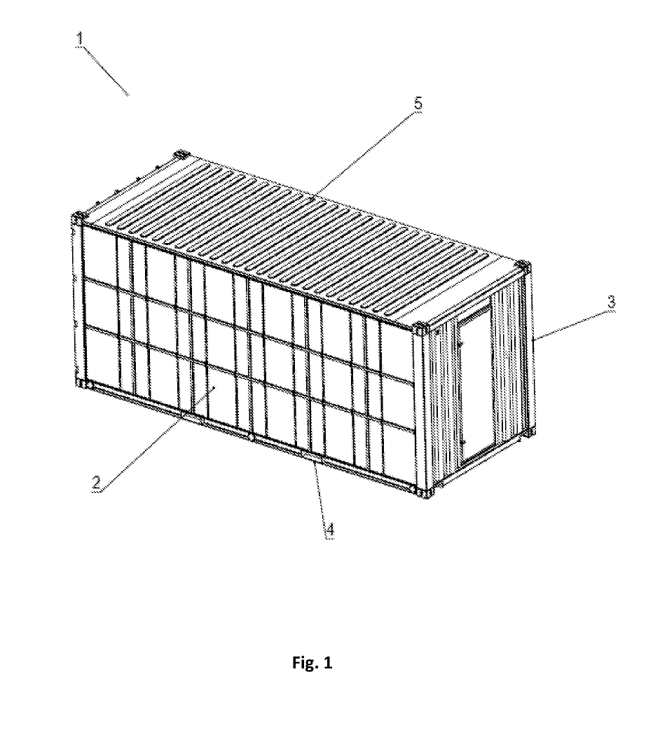

FIGS. 1-8 show an exemplary mobile solar device. The exemplary device includes a rectangular transport type container 1—having two longitudinal side walls 2, two vertically extending front walls 3, a horizontally extending bottom wall 4 and a horizontally extending upper wall 5 in fixed operative connection and which bound a container interior area 27. In the area of longitudinal side walls 2 are rectangular frame structures 8 with construction modules 6 comprising solar panels 7. Each of the plurality of frame structures 8 is suspended inside the container 1 in the transverse extension unit. After opening longitudinal side walls 2, the frame structures 8 are extendable horizontally outside the container 1 through respective vertically extending side openings 26.

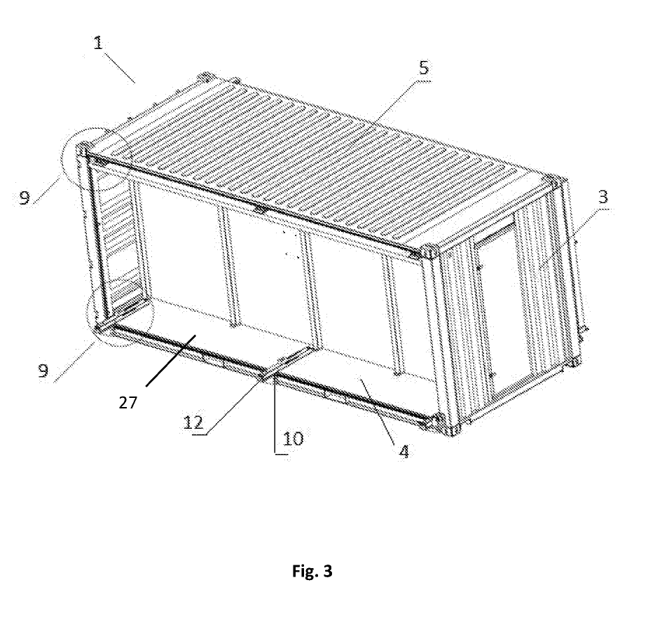

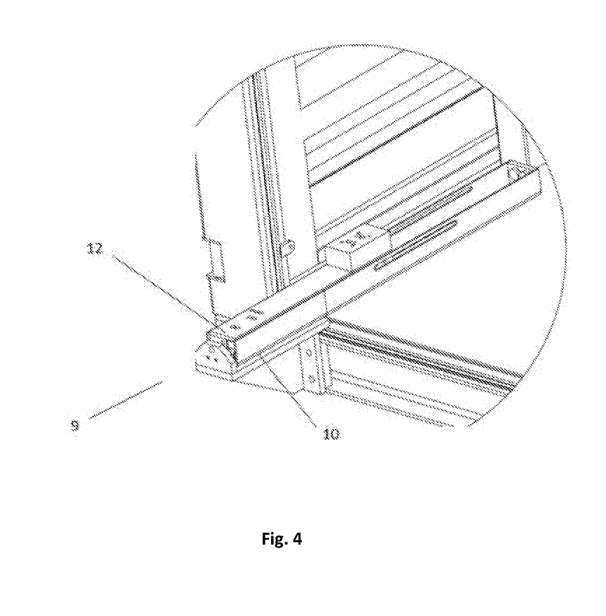

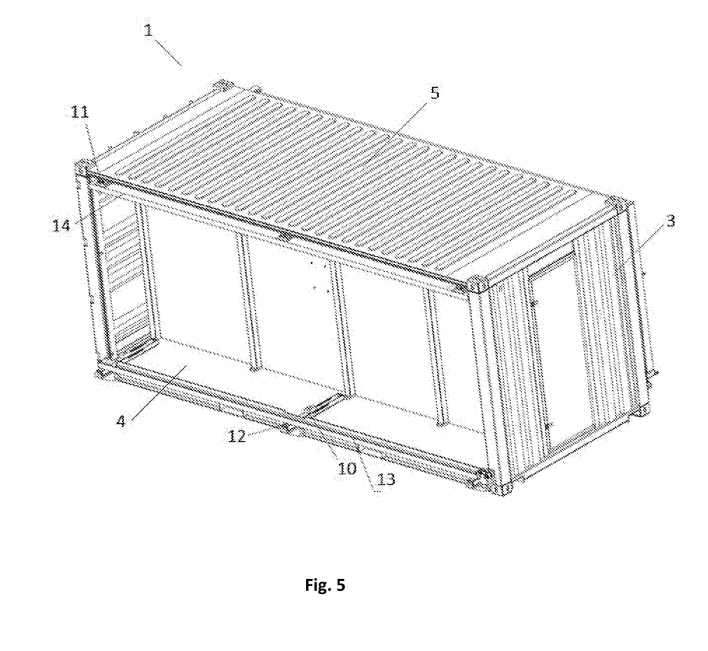

As shown in FIGS. 3-5 a single transverse extension unit 9 comprises a pair of bottom transverse guides 10 and upper transverse guides 11 parallel to each other, which are oriented perpendicular to the longitudinal plane of the side walls 2 and parallel to the front walls of the container. The lower transverse guides and the upper transverse guides are located at and attached to the bottom wall 4 and on the upper wall 5 inside the container 1. The illustrated example embodiment shows three pairs of said bottom transverse guides 10 and upper transverse guides 11, arranged at the bottom wall 4 and on the upper wall 5 in the middle of their length and near two front walls 3. FIG. 4 shows an enlarged view of one of the bottom transverse guides 10, in which a transverse carriage 12 is slidably movably mounted. The analogous design of guiding transverse carriages 12 has been used for the upper transverse guides 11 (not shown). As shown in FIG. 5, a main bottom longitudinal guide 13 and a main upper longitudinal guide 14, respectively are mounted on the bottom transverse guides 10 and upper transverse guides 11 by means of the respective transverse carriages 12.

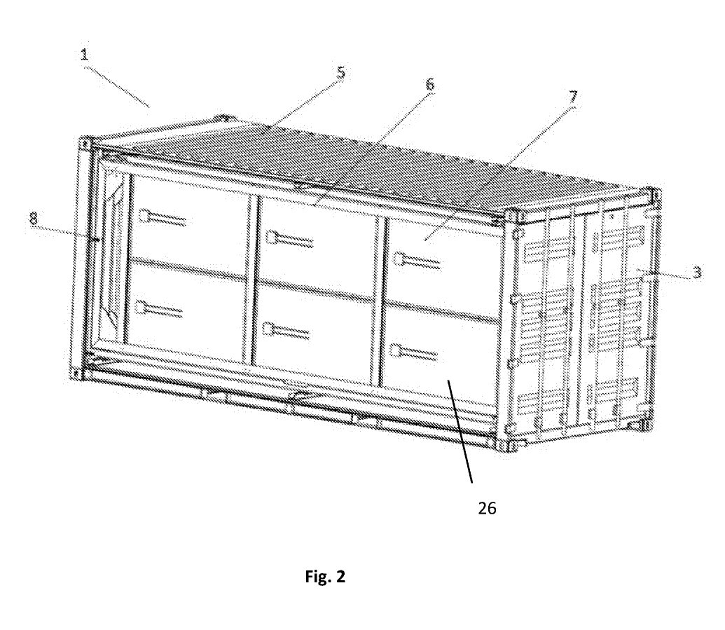

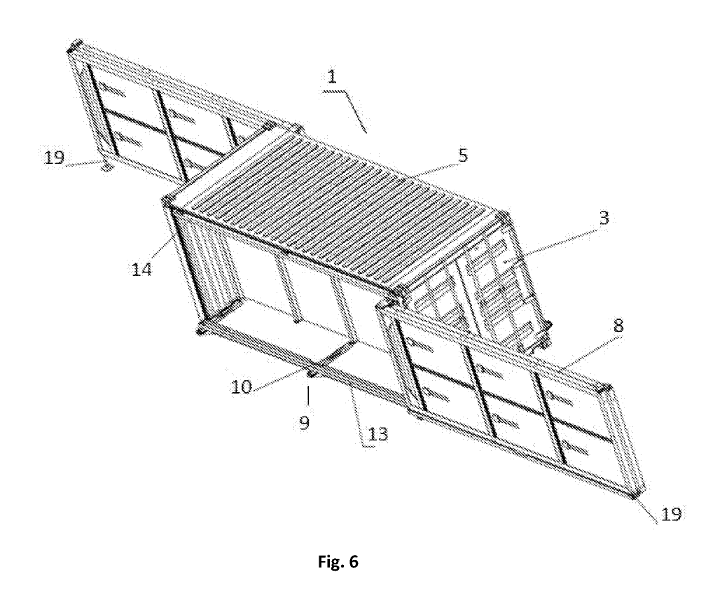

As shown in FIG. 6 frame structure 8 mounted on the main bottom longitudinal guide 13 and main upper longitudinal guide 14 movably slides in a transverse direction along bottom transverse guides 10 and upper transverse guides 11, operatively supported by means of transverse carriages 12 inwardly and outwardly relative to opening 26. The frames are transversely movable from a retracted position within the container interior area 27 as shown in FIG. 2. The exemplary frame structure comprises two rectangular frames including construction modules 6 with the solar panels 7 installed therein in the frames (not shown). In the illustrated embodiment, each of the construction modules 6 comprises six solar panels 7 arranged three in two parallel rows.

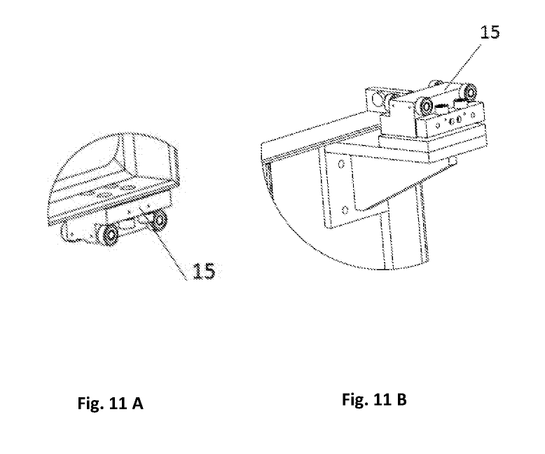

The frames are movable in guided relation with the transverse carriages, from the retracted position to an extended position of the transverse carriages as shown in FIG. 5 and transversely outward beyond the body of the container 1, in aligned relation with the opening 26. The frame structure 8 is further moved laterally in a longitudinal direction in supported connection along said main bottom longitudinal guide 13 and the main upper longitudinal guide 14 by means of longitudinal carriages 15, whose method of attaching to the frame structure from the bottom and from the top is shown in FIGS. 11A and 11B. The said example embodiment includes the structure, in which two frame structures 8, arranged parallel to each other in the retracted position within the container 1, are arranged at the height of each of the longitudinal side walls 2-FIG. 6 for the clarity of the drawing, shows the single pair of extended frame structures 8 in a first longitudinal position in which the frames extend away from the opening 26 and in the longitudinal direction which is perpendicular to the front walls.

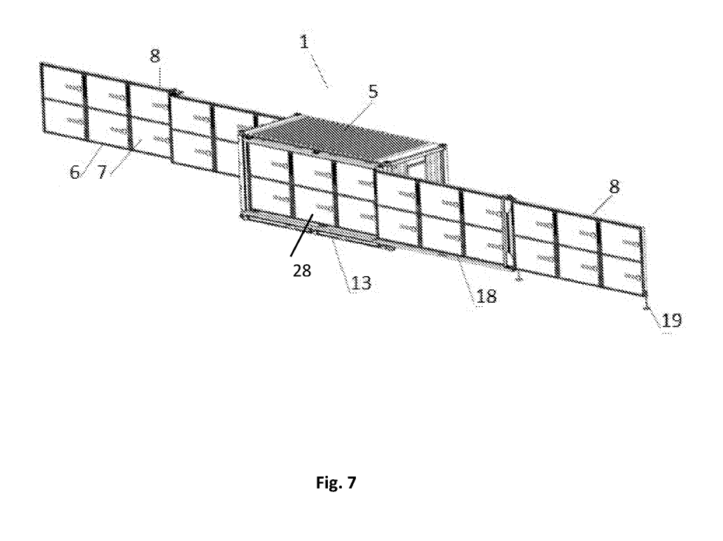

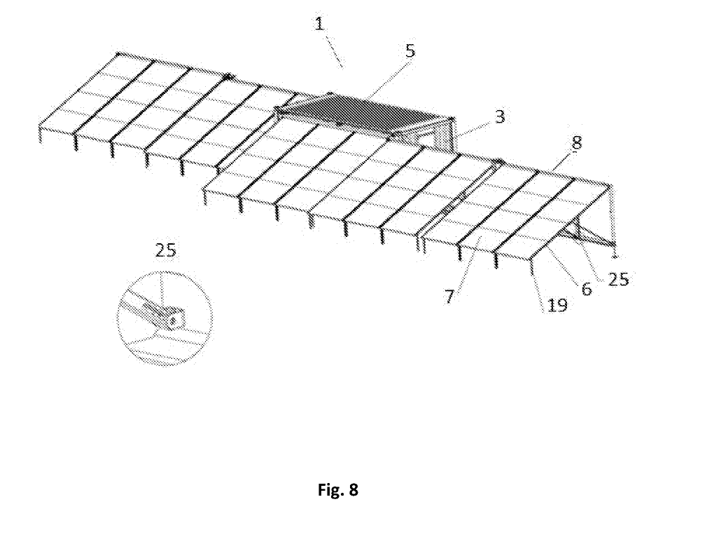

FIGS. 7 and 8 shows the mobile solar device after longitudinally moving the frame structures 8 to an extended position. In the extended position each of the rectangular frames each extend horizontally in the longitudinal direction from the opening 26 and from each other as shown. Frame structures 8 are extended and unfolded outside the container 1 whereby the solar panels may be selectively angularly positioned relative to the frames. In the illustrated embodiment, two frame structures 8 are used along each of longitudinal side walls 2, increasing the efficiency of the solar panels 7. As shown in FIG. 8—when unfolded outside the container 1, the construction modules 6 with the solar panels 7 are selectively angularly positioned from the respective attached frame structure 8 towards the sun. In the illustrated embodiment, articulated angular tilt system 25 is used. Folding legs 19 are extendable downward from the frames.

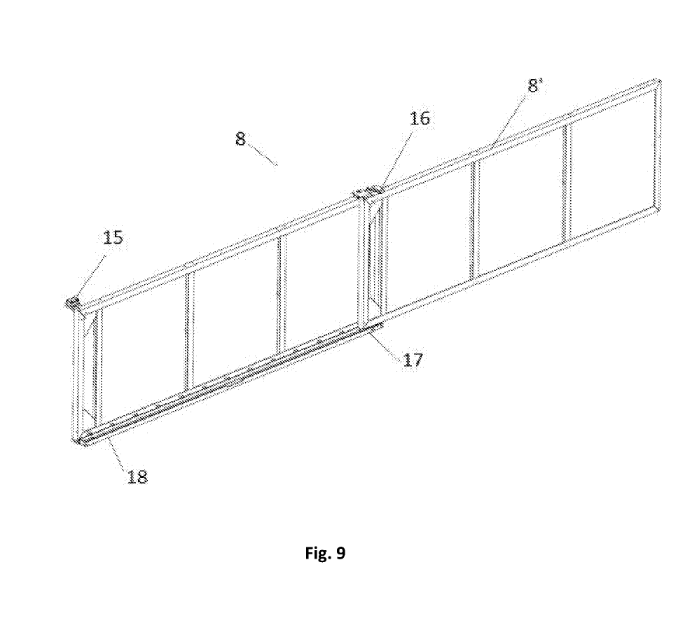

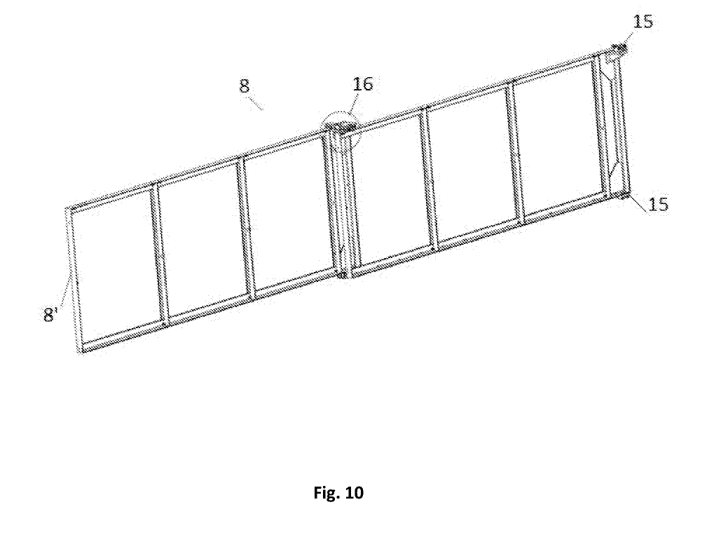

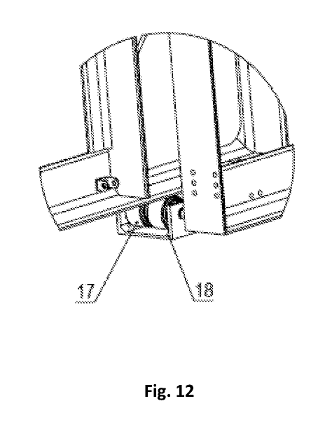

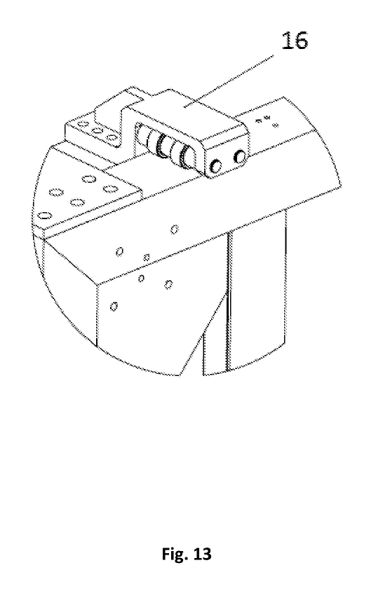

As shown in FIGS. 9 and 10, the frame structure 8 is provided with an extendable frame structure 8′, which initially in the intermediate and first longitudinal positions and for the time of storing inside the container 1 in the retracted position, is oriented in the frame structure 8 so that the frames with construction modules 6 with the solar panels 7 are arranged in parallel with each other. The extendable frame structure 8′ is suspended in the frame structure 8 in the frame longitudinal guide 18 fixed along the bottom side of the frame structure 8. Longitudinal sliding of the frame structure 8′ in supported connection with the longitudinal frame guide is possible by means of a carriage 17, which—as shown in FIG. 12—is slidably mounted in the frame longitudinal guide 18. Additionally, the exemplary extendable frame structure 8′ is provided with rollers 16 mounted on its upper side, which guide the extendable frame structure 8′ along the upper side of the frame structure 8 to the extended position shown I FIG. 7. A detailed view of the rollers 16 guiding the extendable frame structure 8′ is shown in FIG. 13.

Further as shown in FIG. 7, a plurality of rectangular frames 8 each respectively including operatively attached solar panels 7 may be extended from container openings on opposed sides of the container. This may be done for example as shown where a plurality of rectangular frames extend in the longitudinal direction and in a first direction relative to the container, and a further plurality of further rectangular frames extend in the longitudinal direction and in a second direction relative to the container that is opposed of the first direction. The plurality of further rectangular frames are movably operatively supported on respective transverse guides and longitudinal guides and frame guides in a manner like the rectangular frames already discussed. Further as shown in FIG. 7 the exemplary arrangement may further include an additional rectangular frame 28 that like the other rectangular frames includes a plurality of additional solar panels in operatively attached relation therewith. The additional rectangular frame is movably mounted in supported relation with the transverse guides from a position transversely inward of the plurality of frames when in the retracted position, to a position closing the rectangular opening 26 as shown in FIG. 7. The solar panels attached to the additional rectangular panel are also selectively angularly positionable relative to the additional rectangular frame in a manner similar to that of the other solar panels as shown in FIG. 8.

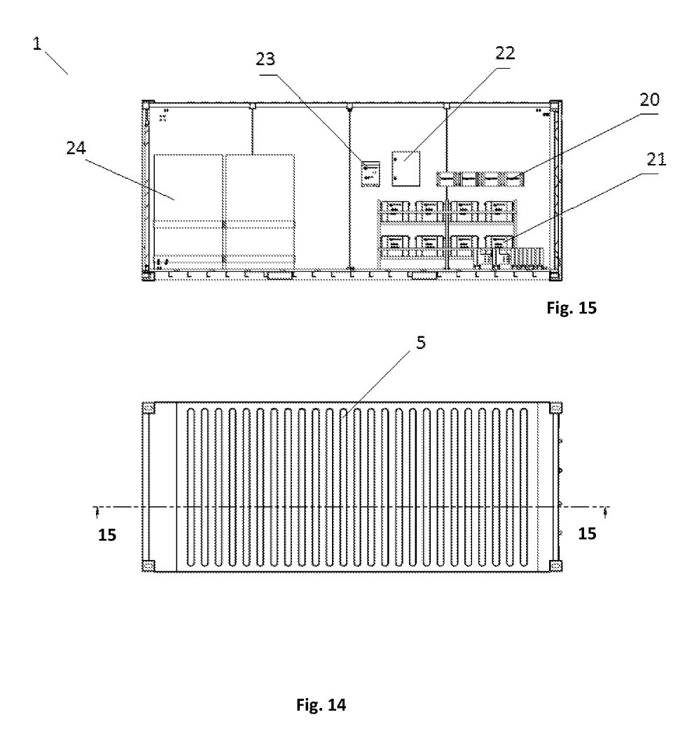

FIG. 14 shows a cross section along the line 15-15 through the container 1 indicating the internal equipment used in the mobile solar device of the embodiment. The container 1 thus comprises charge regulators which are alternatively referred to as a control system 20 and energy batteries 21 set on shelves cooperating with the solar panels 7 embedded in frame structures (not shown). The modules of the equipment of the mobile solar device are connected to the power supplied through the electrical cabinet 22 and the energy inverter 23. In the mobile solar device, there is also a space for spare solar panels 24 which can be replaced in the event of failure or damage to the solar panels 7.

Thus the exemplary arrangements achieve improved operation, eliminate difficulties encountered in the use of prior devices and systems, and attain the useful results described herein.

In the foregoing description, certain terms have been used for brevity, clarity and understanding. However, no unnecessary limitations are to be implied therefrom because such terms are used for descriptive purposes and are intended to be broadly construed. Moreover the descriptions and illustrations herein are by way of examples and the new and useful developments are not limited to the exact features and relationships shown and described.

It should be understood that the features and/or relationships associated with one embodiment can be combined with features and/or relationships from another embodiment. That is, various features and/or relationships from various embodiments can be combined in further embodiments. The new and useful scope of the disclosure is not limited only the embodiments shown or described herein.

Having described features, discoveries and principles of the exemplary arrangements, the manner in which they are constructed and operated, and the advantages and useful results attained, the new useful features, devices, elements, arrangements, parts combinations, systems, equipment, operations, methods, processes and relationships are set forth in the appended claims.

1-11. (canceled)

12. Apparatus comprising:
a container, wherein the container includes
a pair of vertically extending horizontally disposed parallel front walls,
a horizontally extending upper wall,
a horizontally extending bottom wall,
wherein each of the upper wall and the bottom wall are in fixed operative connection with each of the front walls,
wherein the front walls, the upper wall and the bottom wall bound a container interior area,
and wherein the container includes a rectangular opening from outside to the container interior area,
at least one first guide, wherein the at least one first guide
extends within the container interior area,
is mounted in operative supported connection with at least one container wall,
includes at least one carriage, wherein the at least one carriage is movable in guided relation in a transverse direction, wherein the transverse direction is parallel to the front walls,
wherein the at least one carriage is movable in the transverse direction toward and away from the rectangular opening,
at least one second guide, wherein the at least one second guide
is mounted in operatively supported connection with the at least one carriage,
is movable in operative supported connection with the at least one carriage to an extended position, wherein in the extended position the at least one second guide extends outward in the transverse direction from the container opening,
at least one rectangular frame,
a plurality of solar panels, wherein each of the plurality of solar panels is in operatively attached connection with a respective rectangular frame,
wherein the at least one rectangular frame is movably mounted in operatively supported connection with the container through the at least one first guide and the at least one second guide,
wherein the at least one rectangular frame is movable between
a retracted position, wherein in the retracted position the at least one rectangular panel is within the container interior area, and
an intermediate position, wherein in the intermediate position the at least one second guide is in the extended position and the at least one rectangular panel extends in aligned relation with and outwardly from the rectangular opening,
wherein in moving between the retracted position and the intermediate position the at least one carriage moves in the transverse direction relative to the container,
and wherein the at least one rectangular frame is further movable between
the intermediate position, and
a first longitudinal position, wherein in the first longitudinal position the at least one rectangular frame extends perpendicular to the front walls and away from the container opening,
wherein in moving between the intermediate position and the first longitudinal position the at least one carriage is stationary with the at least one second guide in the extended position, and the at least one rectangular frame moves in a longitudinal direction in operatively guided relation with the at least one second guide, wherein the longitudinal direction is perpendicular to the front walls.

13. The apparatus according to claim 12
wherein the at least one rectangular frame comprises a plurality of rectangular frames,
wherein at least one of the plurality of rectangular frames includes at least one frame guide,
wherein at least one rectangular frame is movable in parallel relation with at least one other rectangular frame in operative supported relation with the at least one frame guide,
wherein at least one rectangular frame is further movable between
the first longitudinal position, and
an extended position, wherein in the extended position the at least one rectangular frame extends in operatively supported connection with the at least one frame guide and further outward from the container opening in the longitudinal direction than at least one other rectangular frame,
wherein in moving between the first longitudinal position and the extended position at least one rectangular frame remains in the first longitudinal position and at least one other rectangular frame moves in the longitudinal direction in operatively supported connection with the at least one frame guide.

14. The apparatus according to claim 13
wherein the container further includes
a further rectangular container opening,
wherein the further relationship container opening is on a side of the container opposed of the container opening,
at least one further first guide, wherein the at least one further first guide
extends within the container interior area,
is mounted in operative supported connection with at least one container wall,
includes at least one further carrier, wherein the at least one further carrier is movable in guided relation in the transverse direction,
at least one further second guide, wherein the at least one further second guide
is mounted in operatively supported connection with the at least one further carriage,
is movable in operative supported connection with the at least one further carriage to a further extended position,
wherein in the further extended position the at least one further second guide extends outward in the transverse direction from the further container opening,
at least one further rectangular frame,
a plurality of further solar panels, wherein each of the further solar panels is in operatively attached connection with a respective further rectangular frame,
wherein the at least one further rectangular frame is movably mounted in operatively supported connection with the container through the at least one further first guide and the at least one further second guide,
wherein the at least one further rectangular frame is movable between
a further retracted position, wherein in the further retracted position the at least one further rectangular panel is within the container interior area, and
a further intermediate position, wherein in the further intermediate position the at least one further second guide is in the further extended position and the at least one further rectangular panel extends in aligned relation with and outward from the further rectangular opening,
wherein in moving between the further retracted position and the further intermediate position the at least one further carriage moves in the transverse direction to the further extended position,
and wherein the at least one further rectangular frame is further movable between
the further intermediate position, and
a further first longitudinal position, wherein in the further first longitudinal position the at least one further rectangular frame extends perpendicular to the front walls and away from the further container opening,
wherein in moving between the further intermediate position and the further first longitudinal position the at least one further carriage is stationary and the at least one further second guide is in the further extended position, and the at least one further rectangular frame moves in the longitudinal direction in operatively supported connection with the at least one further second guide.

15. The apparatus according to claim 14
wherein the at least one further rectangular frame comprises a plurality of further rectangular frames,
wherein at least one of the plurality of further rectangular frames includes at least one further frame guide,
wherein at least one further rectangular frame is movable in parallel relation with at least one other further rectangular frame in operative supported relation with the at least one further frame guide,
wherein at least one further rectangular frame is further movable between
the further first longitudinal position, and
a further extended position, wherein in the further extended position the at least one further rectangular frame extends in operatively supported connection with the at least one further frame guide and further outward from the further container opening in the longitudinal direction than at least one other further rectangular frame,
wherein in moving between the further first longitudinal position and the further extended position at least one further rectangular frame remains in the further first longitudinal position and at least one other further rectangular frame moves in the longitudinal direction in operatively supported connection with the at least one further frame guide.

16. The apparatus according to claim 15
wherein in the extended position the plurality of rectangular frames extend in the longitudinal direction away from the container in a first direction,
and wherein in the further extended position the plurality of further rectangular frames extend in the longitudinal direction away from the container in a second direction opposed of the first direction.

17. The Apparatus according to claim 16
wherein each of the plurality of solar panels are selectively angularly positionable relative to the respective rectangular frame,
and wherein each of the plurality of further solar panels are selectively angularly positionable relative to the respective further rectangular frame.

18. The apparatus according to claim 17
wherein the at least one first guide includes
a plurality of lower horizontally spaced first guides and a plurality of upper horizontally spaced first guides,
wherein each of the lower first guides are in operatively attached connection with the bottom wall, and wherein each of the upper first guides are in operatively attached connection with the upper wall.

19. The apparatus according to claim 18
wherein the at least one second guide includes
an upper second guide and a lower second guide,
wherein the upper second guide is in operatively attached connection with the plurality of upper first guides, and wherein the lower second guide is in operatively attached connection with the plurality of lower first guides.

20. the apparatus according to claim 19 and further comprising
an additional rectangular frame,
a plurality of additional solar panels, wherein each of the plurality of additional solar panels is in operative attached connection with the additional rectangular frame,
wherein the additional rectangular frame is transversely movable in the container interior area,
and wherein when the plurality of rectangular frames is in either the first longitudinal position or in the extended position, the additional rectangular frame is transversely movable within the container interior area to be in closing relation with the rectangular container opening.

21. The apparatus according to claim 20
wherein when the plurality of rectangular frames is in the retracted position, the additional rectangular frame is disposed in the container interior area transversely inwardly of the plurality of rectangular frames.

22. the apparatus according to claim 21 and further comprising
at least folding leg, wherein the at least one folding leg is extendable downward from at least one of the plurality of rectangular frames in the extended position,
at least one further folding leg, wherein the at least one further folding leg is extendable downward from at least one of the plurality of further rectangular frames in the further extended position.

23. The apparatus according to claim 22 and further comprising
at least one of a charge regulator, a battery, an electrical cabinet, an energy inverter and a spare solar panel,
wherein the at least one of the charge regulator, the battery, the electrical cabinet the energy inverter and the spare solar panel are housed within the container interior area transversely intermediate of the plurality of rectangular frames in the retracted position and the plurality of further rectangular frames and the further retracted position.

24. The apparatus according to claim 12
wherein each of the plurality of solar panels is selectively angularly positionable relative to the operatively attached respective rectangular frame.

25. The apparatus according to claim 12
wherein the at least one first guide includes
a plurality of lower horizontally spaced first guides and a plurality of upper horizontally spaced first guides,
wherein each of the lower first guides are in operatively attached connection with the bottom wall, and wherein each of the upper first guides are in operatively attached connection with the upper wall.

26. The apparatus according to claim 12
wherein the at least one second guide includes
an upper second guide and a lower second guide,
wherein the upper second guide and the lower second guide are in operatively attached connection with the at least one first guide.

27. The apparatus according to claim 12 and further comprising
an additional rectangular frame,
a plurality of additional solar panels, wherein each of the plurality of additional solar panels is in operative attached connection with the additional rectangular frame,
wherein the additional rectangular frame is transversely movable in the container interior area,
and wherein when the at least one rectangular frame is in other than the retracted position, the additional rectangular frame is transversely movable within the container interior area to be in closing relation with the rectangular container opening.

28. The apparatus according to claim 12
an additional rectangular frame,
a plurality of additional solar panels, wherein each of the plurality of additional solar panels is in operative attached connection with the additional rectangular frame,
wherein the additional rectangular frame is transversely movable in the container interior area,
wherein when the at least one rectangular frame is in the retracted position, the additional rectangular frame is disposed in the container interior area transversely inwardly of the plurality of rectangular frames.

29. The apparatus according to claim 12 and further comprising
at least one folding leg, wherein the at least one folding leg is extendable downward from the at least one rectangular frame when the at least one rectangular frame is in other than the retracted position.

30. The apparatus according to claim 12 and further comprising
at least one of a charge regulator, a battery, an electrical cabinet, an energy inverter and a spare solar panel positioned within the container interior area and transversely of the at least one rectangular frame in the retracted position.

31. Apparatus comprising:
a container, wherein the container bounds a container interior area and includes at least one rectangular vertically extending side opening,
a plurality of rectangular frames, wherein each rectangular frame is in operatively attached connection with at least one solar panel,
at least one first guide, wherein the at least one first guide is in operative attached connection with the container,
at least one second guide, wherein the at least one second guide is in operative attached connection with the at least one first guide,
wherein the plurality of rectangular frames is in operative attached connection with both of the at least one first guide and the at least one second guide,
wherein the plurality of rectangular frames is movable through guided relation via the at least one first guide horizontally in a first direction between a retracted position wherein the plurality of rectangular frames is within the container interior area, and an intermediate position wherein the plurality of rectangular frames is in aligned relation with an extends horizontally outwardly from the side opening, and
wherein the plurality of rectangular frames is movable through guided relation via the at least one second guide horizontally in a second direction perpendicular to the first direction between the intermediate position and an extended position, wherein in the extended position each of the plurality of rectangular frames each extend horizontally in the second direction from the side opening and from each other.
